(19) United States
(12) Patent Application Publication
(10) Pub. No.: US 2025/0113245 A1
(43) Pub. Date: Apr. 3, 2025

(54) TECHNIQUES FOR SYNCHRONOUS COMMUNICATION OF DIFFERENT MODALITIES

(71) Applicant: Lenovo (Singapore) Pte. Ltd., Singapore (SG)

(72) Inventors: Hossein Bagheri, Dearborn Heights, MI (US); Joachim Löhr, Wiesbaden (DE); Vijay Nangia, Woodridge, IL (US)

(21) Appl. No.: 18/900,496

(22) Filed: Sep. 27, 2024

Related U.S. Application Data
(60) Provisional application No. 63/586,345, filed on Sep. 28, 2023.

(51) Int. Cl. H04W 28/02; H04W 80/04

(52) U.S. Cl. CPC H04W 28/0268; H04W 28/0236; H04W 28/0278; H04W 80/04

(57) ABSTRACT

Various aspects of the present disclosure relate to techniques for synchronous communication of different modalities. An apparatus is configured to determine an MM ID associated with multiple correlated traffic flows, receive a configuration for a set of MM-DSR timers, wherein at least one MM-DSR timer in the set of MM-DSR timers is associated with an ordered pair of traffic flows comprising a first traffic flow and a second traffic flow, the first and second traffic flows associated with the same MM ID, and start the at least one MM-DSR timer associated with the first and second traffic flows in response to completion of the first traffic flow, the second traffic flow, or a combination of thereof.

### TECHNICAL FIELD

The present disclosure relates to wireless communications, and more specifically to techniques for synchronous communication of different modalities.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may further determine a multi-modal (MM) traffic identifier (ID) associated with multiple correlated traffic flows, receive a configuration for a set of MM delay status report (DSR) timers, wherein at least one MM-DSR timer in the set of MM-DSR timers is associated with an ordered pair of traffic flows comprising a first traffic flow and a second traffic flow, the first and second traffic flows associated with the same MM ID, and start the at least one MM-DSR timer associated with the first and second traffic flows in response to completion of the first traffic flow, the second traffic flow, or a combination of thereof.

In some implementations of the method and apparatuses described herein, determine a set of MM-DSR timers, transmit a configuration for configuring the set of MM-DSR timers, wherein at least one MM-DSR timer in the set of MM-DSR timers is associated with an ordered pair of traffic flows comprising a first traffic flow and a second traffic flow, the first and second traffic flows associated with the same MM ID, and receive a message indicating a relative latency of completion of the second traffic flow with respect to completion of the first traffic flow via at least one MM-DSR timer of the set of MM-DSR timers.

### BRIEF DESCRIPTION OF THE DRAWINGS

FIG. 1 illustrates an example of a wireless communications system in accordance with aspects of the present disclosure.

FIG. 2 illustrates an example of MM traffic flows and associated timers in accordance with aspects of the present disclosure.

FIG. 3 illustrates an example of a user equipment (UE) in accordance with aspects of the present disclosure.

FIG. 4 illustrates an example of a processor in accordance with aspects of the present disclosure.

FIG. 5 illustrates an example of a network equipment (NE) in accordance with aspects of the present disclosure.

FIG. 6 illustrate a flowcharts of method performed by a UE in accordance with aspects of the present disclosure.

FIG. 7 illustrate a flowcharts of method performed by a NE in accordance with aspects of the present disclosure.

### DETAILED DESCRIPTION

For an extended reality (XR) application, haptic/sensor data, video, and audio data may need to be delivered within a small relative delay. In addition, each of the data streams (video, sensor, etc.) should be delivered within its latency budget. A DSR can be triggered enabling gNB to assign resources to an un-delivered traffic flow getting close to its latency budget. This disclosure builds on the notion of DSR and provides solutions to ensure timely delivery of MM traffic flows.

Aspects of the present disclosure are described in the context of a wireless communications system.

In one embodiment, according to TR 26.928 (incorporated herein by reference), XR is an umbrella term for different types of realities including virtual reality (VR), augmented reality (AR), and mixed reality (MR). In one embodiment, VR is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. Additional means to interact with the virtual reality simulation may be provided but are not strictly necessary.

In one embodiment, AR is when a user is provided with additional information or artificially generated items, or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed.

In one embodiment, MR is an advanced form of AR where some virtual elements are inserted into the physical scene with the intent to provide the illusion that these elements are part of the real scene.

XR, in one embodiment, refers to real and virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

In one embodiment, according to RP-213587 (incorporated herein by reference), many of the XR and CG use cases are characterized by quasi-periodic traffic (with possible jitter) with high data rate in download (DL) (e.g., video steam) combined with the frequent upload (UL) (e.g., pose/control update) and/or UL video stream. Both DL and UL traffic are also characterized by relatively strict packet delay budget (PDB).

In one embodiment, the set of anticipated XR and CG services has a certain variety and characteristics of the data streams (e.g., video) may change “on-the-fly”, while the services are running over new radio (NR). Therefore, additional information on the running services from higher layers, e.g. the quality of service (QOS) flow association, frame-level QoS, ADU-based QoS, XR specific QOS, or the like, may be beneficial to facilitate informed choices of radio parameters. It is clear that XR application awareness by UE and gNB would improve the user experience, improve the NR system capacity in supporting XR services, and reduce the UE power consumption.

In one embodiment, an application data unit (ADU) or a PDU set is the smallest unit of data that can be processed independently by an application (such as processing for handling out-of-order traffic data). A video frame can be an I-frame, P-frame, or can be composed of I-slices, and/or P-slices. I-frames/I-slices are more important and larger than P-frames/P-slices. An ADU can be one or more I-slices, P-slices, I-frame, P-frame, or a combination thereof.

In one embodiment, a service-oriented design considering XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink or MM traffic with synchrony requirements) can enable more efficient (e.g., in terms of satisfying XR service requirements for a greater number of UEs, or in terms of UE power saving) XR service delivery.

In one embodiment, XR-Awareness relies on QoS flows, PDU Sets, Data Bursts and traffic assistance information (see TS 23.501, incorporated herein by reference). Optional PDU Set QoS Parameters may be provided by the SMF to the gNB as part of the QoS profile of the QoS flow.

For instance, PDU Set Delay Budget (PSDB), as defined in TS 23.501, is an upper bound for the duration between the reception time of the first PDU (at the UPF for DL, at the UE for UL) and the time when PDUs of a PDU Set have been successfully received (at the UE in DL, at the UPF in UL). A QOS Flow may be associated with only one PSDB, and when available, it applies to both DL and UL and supersedes the PDB of the QoS flow.

A PDU Set Error Rate (PSER), as defined in TS 23.501, is an upper bound for a rate of non-congestion related PDU Set losses between RAN and the UE. A QOS Flow is associated with only one PSER, and when available, it applies to both DL and UL and supersedes the PER of the QoS flow.

In one embodiment, a PDU set is considered as successfully delivered only when all PDUs of a PDU Set are delivered successfully. In further embodiments, a PDU Set Integrated Handling Information (PSIHI) indicates whether all PDUs of the PDU Set are needed for the usage of PDU Set by application layer, as defined in TS 23.501. In one embodiment, the PDU Set QoS parameters are common for all PDU Sets within a QoS flow.

In one embodiment, the UPF can identify PDUs that belong to PDU Sets, and may determine the following PDU Set Information which it sends to the gNB in the GTP-U header-PDU Set Sequence Number, Indication of End PDU of the PDU Set, PDU Sequence Number within a PDU Set, PDU Set Size in bytes, and PDU Set Importance (PSI), which identifies the relative importance of a PDU Set compared to other PDU Sets within the same QoS Flow.

In one embodiment, traffic assistance information may also be provided by 5GC to the gNB via time sensitive communication (TSC) assistance information (TSCAI) including UL and/or DL Periodicity and N6 Jitter Information (e.g., between UPF and Data Network) associated with the DL Periodicity, or via an indication of End of Data Burst in the GTP-U header of the last PDU in downlink. In one embodiment, in the UL, the UE needs to be able to identify PDU Sets and Data Bursts dynamically, including PSI. How this is done is left up to UE implementation.

In one embodiment, to enhance the scheduling of uplink resources for XR, various improvements are introduced. In one embodiment, an additional BS table is included to reduce the quantization errors in buffer status report (BSR) reporting (e.g. for high bit rates). In such an embodiment, the code points of this new table follow a linear distribution, however, piecewise linearity may be used when defining the BSR table values. Further, in one embodiment, the gNB configures the BS table(s) that a logical channel group (LCG) is eligible to use, and when there is more than one, the UE selects the table.

In one embodiment, an improvement includes delaying knowledge of buffered data, consisting of remaining time, and distinguishing how much data is buffered for which delay. In further embodiments, another improvement includes additional BSR triggering conditions to allow timely availability of buffer status information can be investigated further. In some embodiments, another improvement includes reporting of uplink assistance information (jitter range and burst arrival time) per QoS flow by the UE via UE Assistance Information.

In one embodiment, a new, separate medium access control (MAC) control element (CE) for DSR reporting is defined, e.g. DSR reporting is not coupled with BSR reporting. In such an embodiment, threshold based DSR reporting is supported, e.g. DSR reporting is triggered when the remaining delay is below a network (NW) configured threshold. In one embodiment, the threshold is configured per LCG.

In one embodiment, when the PSIHI is set for a QoS flow, as soon as one PDU of a PDU set is known to be lost, the remaining PDUs of that PDU Set can be considered as no longer needed by the application and may be subject to discard operation at the transmitter to free up radio resources. In such an embodiment, it may not be assumed that the remaining PDUs are not useful and can safely be discarded. Also, in case of Forward Error Correction (FEC), active discarding of PDUs, when assuming that a large enough number of packets have already been transmitted for FEC to recover without the remaining PDUs, may not be recommended as it might trigger an increase of FEC packets.

In one embodiment, in UL, the UE may be configured with PDU Set based discard operation for a specific data radio bearer (DRB). When configured, the UE discards all packets in a PDU set when one PDU belonging to this PDU set is discarded, e.g. based on discard timer expiry. In one embodiment, in case of congestion, the PSI may be used for PDU set discarding. In UL, dedicated signaling is used to trigger discard mechanism based on PSI.

In one embodiment, Multiple configured grant (CG) physical uplink shared channel (PUSCH) transmission occasions in a period of a single CG PUSCH configuration may be used. Further, in one embodiment, dynamic indication of unused CG PUSCH occasion(s) based on uplink control information (UCI) (e.g., CG-UCI or a new UCI, referred to as UTO-UCI) by the UE may be used.

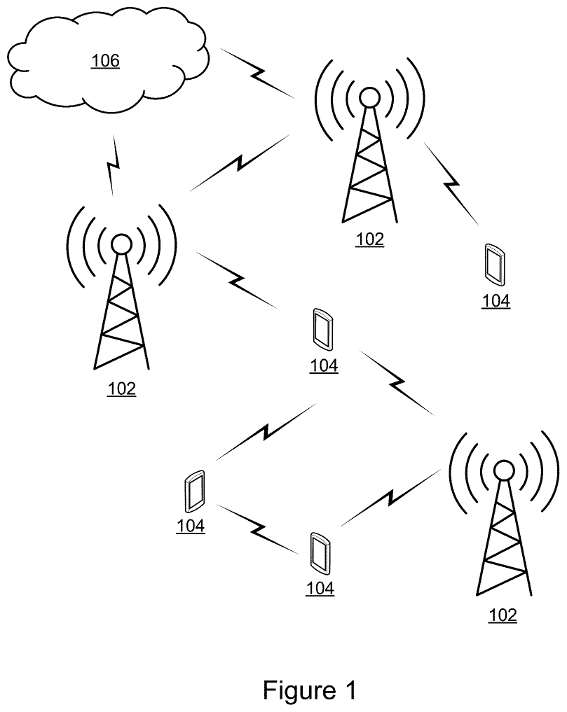

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The solutions described below are directed to the use of MM-DSR timers for MM traffic. In one embodiment, an application generates data once MM traffic flows start generating data (e.g., haptic samples might start one second earlier than video frames; but MM communication starts when there are samples available for all of the correlated streams—e.g., video, audio, and haptic samples are started to be generated).

In one embodiment, a UE has an MM traffic flow consisting of ‘n’ associated traffic flows, logical channels (LCHs), LCGs, DRBs, or the like (referred to as TF1, . . . , TFn), which may be linked together via a MM-flow coordination ID. In such an embodiment, the UE or gNB sends a MAC-CE or another activation command indicating activation/start of MM transmission (which could be useful for LCP enhancements) to the gNB or UE, respectively.

In one embodiment, the UE is configured with ‘m’ timers (such as ‘m’ timer values), where e.g., ‘m’<=‘n×(n−1)’. Upon completion or alternatively, upon starting of transmission of a packet (or a PDU set) from a first flow of the ‘n’ flows, the UE may determine whether to start a first subset of timers.

In such an embodiment, the packet or PDU set is the first packet or PDU set of the first flow where the associated timer(s) is not running, and the arrival of the first packet is within a configured time window from a reference time. In one embodiment, the reference time can be determined based on a traffic characteristic, such as nominal arrival time of a video frame; a configuration (e.g., based on a periodicity, and an offset with respect to a subframe/slot); and/or the application may know and provide the UE with which packets are linked together.

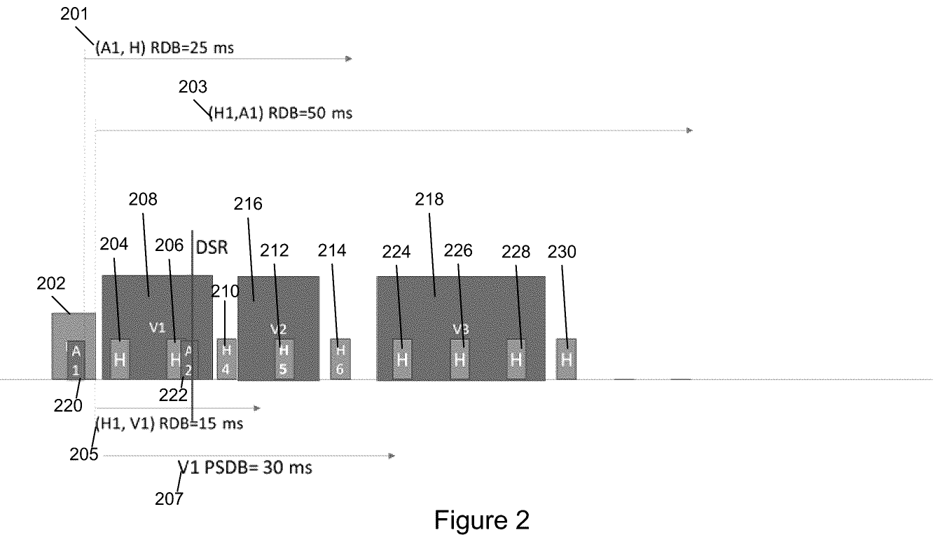

For example, FIG. 2 depicts MM traffic that comprises video traffic (V1 208, V2 216, V3 218), audio traffic (A1 220, A2 222), and haptic traffic (H1 202, H2 204, H3 206, H4 210, H5 212, H6 214, H7 224, H8 226, H9 228, H10 230). Upon completion of the first audio PDU/PDU set (shown by A1 220), the UE starts a timer associated with audio and haptic traffic (shown by (A1, H) RDB 201) with a timer value of 25 ms, and upon completion of the first haptic PDU/PDU set (shown by H1 202), the UE starts two timers-timer 1 associated with haptic and audio traffic (shown by (H1,A1) RDB 203) with a timer value of 50 ms and timer 2 associated with haptic and video traffic (shown by (H1, V1) RDB 205) with a timer value of 15 ms. In one embodiment, the video traffic has its own DSR timer 207 with a value of 30 ms. In one embodiment, the UE, through the application, knows H1 202, H2 204, and H3 206 are linked to V1 208, and H4 210, H5 212, and H6 214 are linked to V2 216, and so on.

In one embodiment, a timer is defined for an ordered pair of traffic flows, with an entry or both entries of the pair may comprise of multiple traffic flows. Timer values may be configured or determined based on a MM configuration. In one embodiment, completion is defined by not receiving a dynamic grant scheduling a retransmission of a transport block (TB) (or the last few TBs of the PDU/PDU set) associated with the packet (PDU set) within a configured/determined amount of time.

In another embodiment, completion is defined by, in the case of CG configuration with automatic retransmission, not transmitting a re-transmission of a TB associated with the packet within a configured/determined amount of time. In one embodiment, completion occurs when the associated buffer is flushed. In one embodiment, completion occurs when the MAC PDU for the packet/PDU set (e.g., the last PDU of the PDU set) has been successfully received, and the UE receives a downlink control information (DCI) (with new data indicator (NDI) toggled) scheduling a new TB with the same hybrid automatic repeat request (HARQ) process ID as the previously scheduled UL transmission (of the PDU/PDU set) or the UE receives a Downlink Feedback Indicator (DFI) indicating an acknowledgement to a TB of the MAC PDU.

In one embodiment, the starting of a transmission of a packet is defined by the time instance for which the packet is scheduled to be transmitted (the time instance associated with the first TB of the packet/PDU/PDU set). In certain embodiments, the timer value is decreased every time unit where the data (e.g., a PDU set) of one element of the pair of traffic flows has not been completed yet.

In certain embodiments, if a timer value falls below a first configured threshold, a MM-DSR is triggered. The triggered MM-DSR may convey a timer ID indicating relative delay budget of which traffic flows/types is getting smaller than the first configured threshold. In one embodiment, the UE sends a MAC-CE containing the MM-DSR if there are not sufficient resources available to transmit all the traffic associated with the timer.

For example, the UE may have received a multi-PUSCH grant e.g., comprising four slots. If a timer value falls below the first threshold before the first slot of the four slots, and if the UE has sufficient resources to transmit all the associated data by the end of the fourth slot, the UE would not trigger the MM-DSR, or would cancel the triggered MM-DSR, or it can be radio resource control (RRC) configured to trigger/transmit MM-DSR.

If the timer value falls below a second configured threshold (or after a certain time from the time the MM-DSR was sent), and no grant is yet assigned to the UE to transmit the data, a scheduling request (SR) is triggered. The triggered SR may convey a timer ID indicating relative delay budget of which (pair of) traffic flows/types is getting smaller than the second threshold. In one embodiment, the network may configure one of the thresholds. In one embodiment, if a second timer value falls below a corresponding threshold, a second MM-DSR can be triggered when at least a certain time is passed from the time the first MM-DSR is triggered.

In one embodiment, if a timer is expired and there is uncompleted data associated with the timer, the UE stops the “m” timers or considers all of the timers expired, and the associated packets/PDU sets are discarded. In one embodiment, whether to discard the associated packets/PDU sets can be subject to an RRC configuration.

In one embodiment, the UE sends a MAC-CE in response to a triggered MM-DSR or DSR using the same Logical channel ID (LCID) or extended LCID (eLCID) for the corresponding MAC subheader.

In one embodiment, if a PDU set is discarded (e.g., due to expiry of a packet data convergence protocol (PDCP) discard timer), the ‘m’ MM-DSR timers are considered expired. In one embodiment, if a DSR for an LCG is triggered, and the corresponding MAC-CE is sent, the UE upto configuration can have an MM-DSR associated with the LCG if triggering conditions are satisfied, and can transmit the corresponding MAC-CE, and/or the UE cancels a triggered MM-DSR associated with the LCG (not transmit the associated MAC-CE).

In one embodiment, if the corresponding MAC-CE is not yet sent, the UE determines e.g., based on which of the DSR or MM-DSR indicating a smaller value, to transmit MAC-CE corresponding to DSR or MM-DSR. This may be a similar procedure as above, where MM-DSR and DSR are switched.

In one embodiment, a MAC PDU contains at most one BSR MAC-CE or one DSR MAC-CE or one MM-DSR MAC-CE, even when multiple events have triggered a BSR, DSR, and/or MM-DSR. In one embodiment, the DSR or MM-DSR has precedence over BSR. In certain embodiments, between DSR and MM-DSR, whichever implies a shorter delay budget has precedence over the other.

In one embodiment, the DSR or MM-DSR has precedence over BSR if the associated flows, LCHs, LCGs, or the like have higher priority than those indicated by BSR. Alternatively, in one embodiment, a MAC PDU shall contain (at most) one BSR MAC-CE, XR-BSR MAC-CE, DSR MAC-CE, and MM-DSR MAC-CE.

For example, “X1” BSR MAC-CE, “X2” XR-BSR MAC-CE, “X3” DSR-MAC-CE, and “X4” MM-DSR-MAC-CE, where “X1”, “X2”, “X3”, and “X4” are selected from {0, 1}, and can be reported via UE capability reporting, can be configured, or can be fixed in specifications.

In one embodiment, triggered DSRs and/or MM-DSRs may be cancelled when the UL grant(s) can accommodate all pending data available for transmission associated with the DSRs and/or MM-DSRs, but is not sufficient to additionally accommodate the corresponding MAC CE plus its subheader.

In one embodiment, DSRs and/or MM-DSRs triggered (associated with a particular LCG) prior to MAC PDU assembly shall be cancelled when a MAC PDU is transmitted and the MAC PDU includes a DSR/MM-DSR MAC CE (associated with the particular LCG), which contains delay status up to (and including) the last event that triggered a DSR/MM-DSR (associated with the particular LCG) prior to the MAC PDU assembly.

In one embodiment, the fields in the MM-DSRT MAC-CE are defined as shown below. Below is an example of a short MM-DSR MAC-CE. The relative delay field size may be 0.

| | |
|---|---|
| Super-LCG ID; e.g., ({LCG1}, {LCG2}) | Relative Delay |

In another embodiment, MM-DSR MAC-CE may contain buffer size information for the associated traffic flows. In this example, LCG1 and LCG2 are associated, and the MM-DSR MAC-CE contains relative delay information for LCG1 and LCG2. The buffer size field size for {LCG1} may be 0.

| | | | |
|---|---|---|---|
| Super-LCG ID; e.g., | Relative Delay | Buffer Size for | Buffer Size for |
| ({LCG1}, {LCG2}) | | {LCG1} | {LCG2} |

If more than one LCG, in case of DSR, or one LCG pair, in case of MM-DSR, have latency budgets that are not larger than their associated thresholds, or alternatively, if at least one LCG, in case of DSR, and one LCG pair, in case of MM-DSR, has latency budgets that are not larger than their associated threshold, when the MAC PDU containing the DSR or MM-DSR is to be built, the UE reports Long DSR or MM-DSR for LCGs/LCG pairs (which have been configured, e.g., for multi-modal communication or have latency or relative delay/latency requirements). Otherwise, in one embodiment, the UE reports Short DSR or MM-DSR.

Below is an example of a long MM-DSR:

| | | | |
|---|---|---|---|
| Super-LCG ID; e.g., | Relative Delay | Buffer Size for | Buffer Size for |
| ({LCG1}, {LCG2}) | | {LCG1} | {LCG2} |
| Super-LCG ID; e.g., | Relative Delay | Buffer Size for | Buffer Size for |
| ({LCG1}, {LCG3}) | | {LCG1} | {LCG3} |
| Super-LCG ID; e.g., | Relative Delay | Buffer Size for | Buffer Size for |
| ({LCG2}, {LCG3}) | | {LCG2} | {LCG3} |
| Super-LCG ID; e.g., | Relative Delay | Buffer Size for | Buffer Size for |
| ({LCG2}, {LCG1}) | | {LCG2} | {LCG1} |

In one embodiment, the super-LCG ID can be determined based on ordered linkage of LCGs. For instance, if there exists ‘W’ LCG IDs, and LCG1, LCG2, and LCG3 form a multi-modal traffic, additional LCG IDs can be defined, as below:

| Super-LCG ID | Index referring to the ordered pair of LCG groups |
|---|---|
| W + 1 | ({LCG1}, {LCG2}) |
| W + 2 | ({LCG1}, {LCG3}) |
| W + 3 | ({LCG2}, {LCG1}) |
| W + 4 | ({LCG2}, {LCG3}) |
| W + 5 | ({LCG3}, {LCG1}) |
| W + 6 | ({LCG3}, {LCG2}) |

In one embodiment, indicating MM-DSR for different pairs of traffic flows can be useful e.g., when reliability and or latency requirements of these flows are different. IN one embodiment, the MM-delay levels (in ms) for a 2-bit delay level indication can be as follows, where the first threshold>X>Y>Z. For first threshold=5 ms, X=4 ms, Y=3 ms, Z=2 ms, first threshold, X, Y, Z can be configured and can depend on subcarrier spacing (SCS), if the MM-traffic is handled by carriers with the same SCS, and a pair of LCGs. For example, (first threshold, X, Y, Z) can be different for different pairs of LCGs.

In one embodiment, a latency or delay level is indicated from a set of latency or delay levels in a DSR or in a MM-DSR. The UE determines the latency or delay level based on the time of the transmission of the corresponding MAC-CE, and possible quantized values in a table of possible delay/latency values (e.g., as shown below) by indicating the largest delay/latency entry of the table that is not larger than the actual delay/latency of the traffic flow(s) computed based on the time of transmission of the corresponding MAC-CE.

| Index | relative-delay level |
|---|---|
| 1 | first threshold |
| 2 | X ms |
| 3 | Y ms |
| 4 | Z ms |

To summarize, the subject matter disclosed herein describes configuring aspects of timers to track inter-flow latency of MM traffic, conditions for starting/stopping of those timers, priority/precedence of BSR, DSR, and MM-DSR, and the Structure of MM-DSR. In one embodiment, the UE is configured with an MM traffic ID linking multiple correlated traffic flows together and configured with a set of MM-DSR timers, wherein each timer is associated with an ordered pair of traffic flows. The timer may be started when a traffic flow of the pair of traffic flows is completed. In one embodiment, the UE sends (at most) one MM-DSR and DSR from a set of triggered MM-DSR and DSRs in a MAC-PDU, and precedence is given to the one that approaches the delay budget sooner. In one embodiment, the MM-DSR has a short and a long format and includes an LCG pair ID associated to each relative delay.

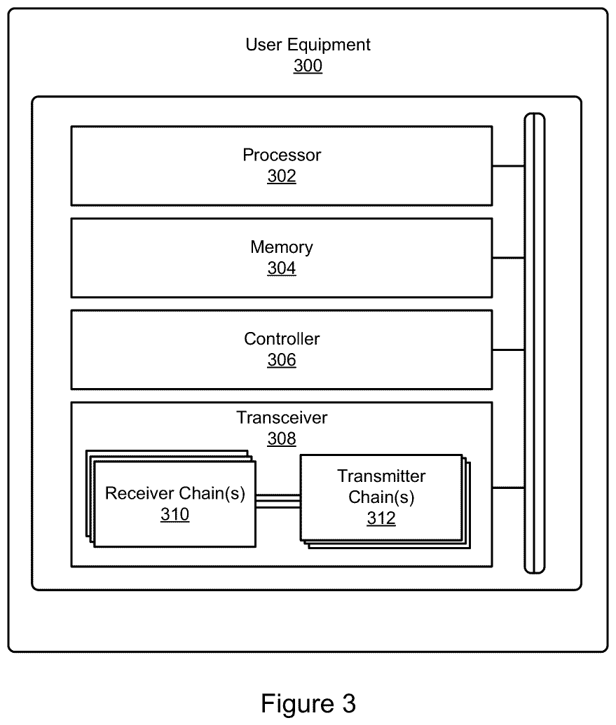

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a CPU, an ASIC, an FPGA, or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions that, when executed by the processor 302, cause the UE 300 to perform various functions described herein. The code may be stored in a non-transitory computer-readable medium such the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the functions described herein (e.g., executing, by the processor 302, instructions stored in the memory 304). For example, the processor 302 may support wireless communication at the UE 300 in accordance with examples as disclosed herein. The UE 300 may be configured to support a means to determine an MM traffic ID associated with multiple correlated traffic flows. The UE 300 may be configured to support a means to receive a configuration for a set of MM-DSR timers, wherein at least one MM-DSR timer in the set of MM-DSR timers is associated with an ordered pair of traffic flows comprising a first traffic flow and a second traffic flow, the first and second traffic flows associated with the same MM ID. The UE 300 may be configured to support a means to start the at least one MM-DSR timer associated with the first and second traffic flows in response to completion of the first traffic flow, the second traffic flow, or a combination of thereof.

In one embodiment, the first traffic flow or the second traffic flow is completed in response to a set of associated packets of the first traffic flow or second traffic flow, respectively, being delivered.

In one embodiment, the UE 300 may be configured to support a means to, in response to starting the at least one MM-DSR timer, track a relative latency budget of completion of the second traffic flow with respect to completion of the first traffic flow via the at least one MM-DSR timer, and wherein the latency budget shrinks in response to the second traffic flow being completed.

In one embodiment, the UE 300 may be configured to support a means to stop the at least one MM-DSR timer at least based on exhausting the relative latency budget. In one embodiment, the UE 300 may be configured to support a means to transmit a MAC-CE message indicating the relative latency budget.

In one embodiment, the UE 300 may be configured to support a means to transmit the MAC-CE message in response to absence of pending MM-DSRs, DSRs, BSRs, or a combination thereof that have a higher priority than the at least one MM-DSR and wherein a DSR comprises an absolute latency budget of a traffic flow, and a BSR comprises a buffer status report.

In one embodiment, pending MM-DSRs or DSRs have higher priorities than the at least one MM-DSR in response to an associated latency budget of the pending MM-DSRs or DSRs being less than the latency budget of the at least one MM-DSR. In one embodiment, the MAC-CE message comprises an associated buffer size for the second traffic flow.

In one embodiment, the UE 300 may be configured to support a means to trigger a first MM-DSR event in response to a value of the at least one MM-DSR timer being less than a threshold.

In one embodiment, the UE 300 may be configured to support a means to start the at least one MM-DSR timer in response to the at least one MM-DSR timer not being started prior to a packet of the first traffic flow being delivered.

In one embodiment, the UE 300 may be configured to support a means to start the at least one MM-DSR timer in response to the completion of at least a packet of the first traffic flow which has arrived in a buffer of the UE within a predetermined time window.

In one embodiment, the UE 300 may be configured to support a means to stop the at least one MM-DSR timer in response to exhaustion of a relative latency budget of at least one of the set of MM-DSR timers or exhaustion of an absolute latency budget of at least a packet of one of the multiple correlated traffic flows.

In one embodiment, the UE 300 may be configured to support a means to discard remaining packets of the multiple correlated traffic flows associated with the first traffic flow in response to the MM-DSR timer expiring.

The controller 306 may manage input and output signals for the UE 300. The controller 306 may also manage peripherals not integrated into the UE 300. In some implementations, the controller 306 may utilize an operating system such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas for receiving the signal over the air or wireless medium. The receiver chain 310 may include at least one amplifier (e.g., a low-noise amplifier (LNA)) configured to amplify the received signal. The receiver chain 310 may include at least one demodulator configured to demodulate the received signal and obtain the transmitted data by reversing the modulation technique applied during transmission of the signal. The receiver chain 310 may include at least one decoder for decoding the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

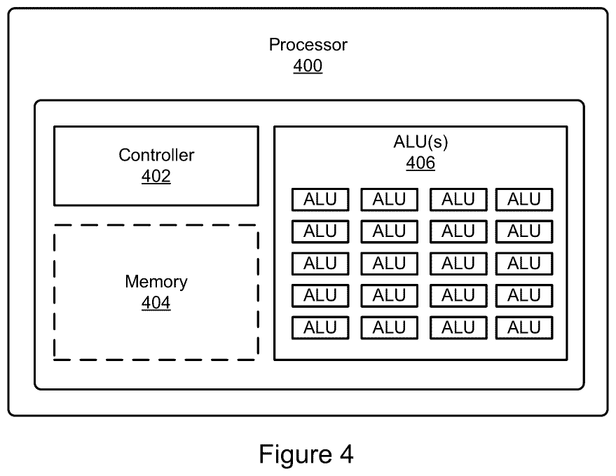

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory address of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, arithmetic logic units (ALUs), and other functional units of the processor 400.

The memory 404 may include one or more caches (e.g., memory local to or included in the processor 400 or other memory, such RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, the controller 402, and the memory 404 may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

The processor 400 may support wireless communication in accordance with examples as disclosed herein. The processor 400 may be configured to or operable to support a means to determine an MM traffic ID associated with multiple correlated traffic flows. The processor 400 may be configured to support a means to receive a configuration for a set of MM-DSR timers, wherein at least one MM-DSR timer in the set of MM-DSR timers is associated with an ordered pair of traffic flows comprising a first traffic flow and a second traffic flow, the first and second traffic flows associated with the same MM ID. The processor 400 may be configured to support a means to start the at least one MM-DSR timer associated with the first and second traffic flows in response to completion of the first traffic flow, the second traffic flow, or a combination of thereof.

In one embodiment, the first traffic flow or the second traffic flow is completed in response to a set of associated packets of the first traffic flow or second traffic flow, respectively, being delivered.

In one embodiment, the processor 400 may be configured to support a means to, in response to starting the at least one MM-DSR timer, track a relative latency budget of completion of the second traffic flow with respect to completion of the first traffic flow via the at least one MM-DSR timer, and wherein the latency budget shrinks in response to the second traffic flow being completed.

In one embodiment, the processor 400 may be configured to support a means to stop the at least one MM-DSR timer at least based on exhausting the relative latency budget. In one embodiment, the processor 400 may be configured to support a means to transmit a MAC-CE message indicating the relative latency budget.

In one embodiment, the processor 400 may be configured to support a means to transmit the MAC-CE message in response to absence of pending MM-DSRs, DSRs, BSRs, or a combination thereof that have a higher priority than the at least one MM-DSR and wherein a DSR comprises an absolute latency budget of a traffic flow, and a BSR comprises a buffer status report.

In one embodiment, pending MM-DSRs or DSRs have higher priorities than the at least one MM-DSR in response to an associated latency budget of the pending MM-DSRs or DSRs being less than the latency budget of the at least one MM-DSR. In one embodiment, the MAC-CE message comprises an associated buffer size for the second traffic flow.

In one embodiment, the processor 400 may be configured to support a means to trigger a first MM-DSR event in response to a value of the at least one MM-DSR timer being less than a threshold.

In one embodiment, the processor 400 may be configured to support a means to start the at least one MM-DSR timer in response to the at least one MM-DSR timer not being started prior to a packet of the first traffic flow being delivered.

In one embodiment, the processor 400 may be configured to support a means to start the at least one MM-DSR timer in response to the completion of at least a packet of the first traffic flow which has arrived in a buffer within a predetermined time window.

In one embodiment, the processor 400 may be configured to support a means to stop the at least one MM-DSR timer in response to exhaustion of a relative latency budget of at least one of the set of MM-DSR timers or exhaustion of an absolute latency budget of at least a packet of one of the multiple correlated traffic flows.

In one embodiment, the processor 400 may be configured to support a means to discard remaining packets of the multiple correlated traffic flows associated with the first traffic flow in response to the MM-DSR timer expiring.

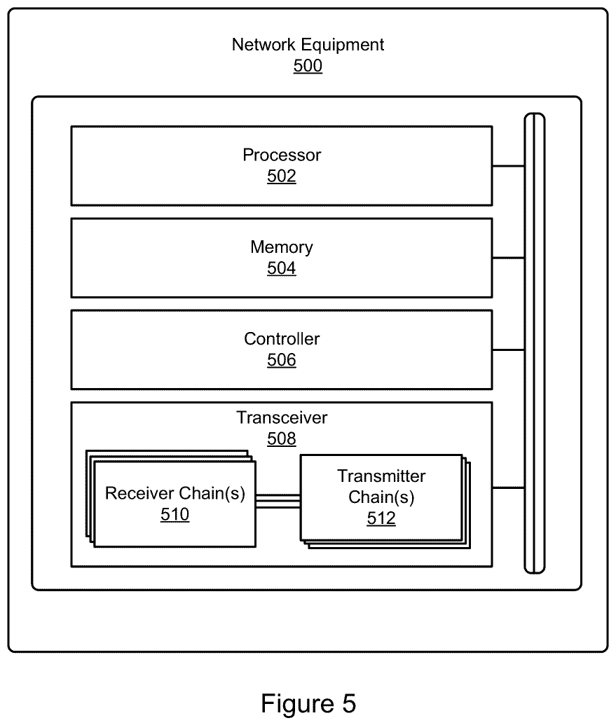

FIG. 5 illustrates an example of a NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions that, when executed by the processor 502, cause the NE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the functions described herein (e.g., executing, by the processor 502, instructions stored in the memory 504). For example, the processor 502 may support wireless communication at the NE 500 in accordance with examples as disclosed herein. The NE 500 may be configured to support a means to determine a set of MM-DSR timers. The NE 500 may be configured to support a means to transmit a configuration for configuring the set of MM-DSR timers, wherein at least one MM-DSR timer in the set of MM-DSR timers is associated with an ordered pair of traffic flows comprising a first traffic flow and a second traffic flow, the first and second traffic flows associated with the same MM ID. The NE 500 may be configured to support a means to receive a message indicating a relative latency of completion of the second traffic flow with respect to completion of the first traffic flow via at least one MM-DSR timer of the set of MM-DSR timers.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

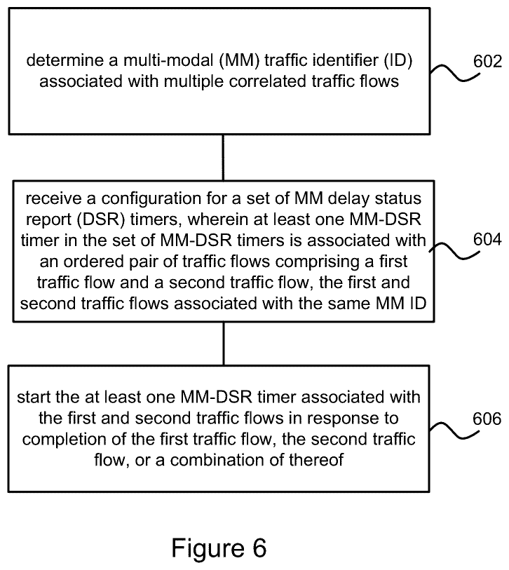

FIG. 6 illustrates a flowchart of a method in accordance with aspects of the present disclosure. The operations of the method may be implemented by a UE as described herein. In some implementations, the UE may execute a set of instructions to control the function elements of the UE to perform the described functions.

At 602, the method may determine an MM traffic ID associated with multiple correlated traffic flows. The operations of 602 may be performed in accordance with examples as described herein. In some implementations, aspects of the operations of 602 may be performed by a UE as described with reference to FIG. 3.

At 604, the method may receive a configuration for a set of MM-DSR timers, wherein at least one MM-DSR timer in the set of MM-DSR timers is associated with an ordered pair of traffic flows comprising a first traffic flow and a second traffic flow, the first and second traffic flows associated with the same MM ID. The operations of 604 may be performed in accordance with examples as described herein. In some implementations, aspects of the operations of 604 may be performed by a UE as described with reference to FIG. 3.

At 606, the method may start the at least one MM-DSR timer associated with the first and second traffic flows in response to completion of the first traffic flow, the second traffic flow, or a combination of thereof. The operations of 606 may be performed in accordance with examples as described herein. In some implementations, aspects of the operations of 606 may be performed a UE as described with reference to FIG. 3.

It should be noted that the method described herein describes A possible implementation, and that the operations and the steps may be rearranged or otherwise modified and that other implementations are possible.

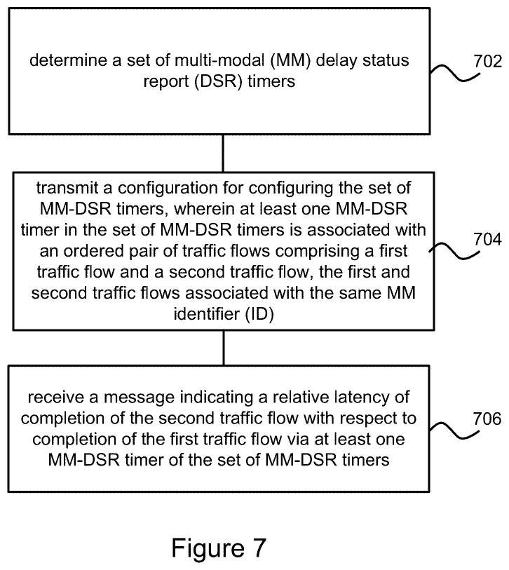

FIG. 7 illustrates a flowchart of a method in accordance with aspects of the present disclosure. The operations of the method may be implemented by a NE as described herein. In some implementations, the NE may execute a set of instructions to control the function elements of the NE to perform the described functions.

At 702, the method may determine a set of MM-DSR timers. The operations of 702 may be performed in accordance with examples as described herein. In some implementations, aspects of the operations of 702 may be performed by a NE as described with reference to FIG. 5.

At 704, the method may transmit a configuration for configuring the set of MM-DSR timers, wherein at least one MM-DSR timer in the set of MM-DSR timers is associated with an ordered pair of traffic flows comprising a first traffic flow and a second traffic flow, the first and second traffic flows associated with the same MM identifier (ID). The operations of 704 may be performed in accordance with examples as described herein. In some implementations, aspects of the operations of 704 may be performed by a NE as described with reference to FIG. 5.

At 706, the method may receive a message indicating a relative latency of completion of the second traffic flow with respect to completion of the first traffic flow via at least one MM-DSR timer of the set of MM-DSR timers. The operations of 706 may be performed in accordance with examples as described herein. In some implementations, aspects of the operations of 706 may be performed a NE as described with reference to FIG. 5.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
determine a multi-modal (MM) traffic identifier (ID) associated with multiple correlated traffic flows;
receive a configuration for a set of MM delay status report (DSR) timers, wherein at least one MM-DSR timer in the set of MM-DSR timers is associated with an ordered pair of traffic flows comprising a first traffic flow and a second traffic flow, the first and second traffic flows associated with the same MM ID; and
start the at least one MM-DSR timer associated with the first and second traffic flows in response to completion of the first traffic flow, the second traffic flow, or a combination of thereof.

2. The UE of claim 1, wherein the first traffic flow or the second traffic flow is completed in response to a set of associated packets of the first traffic flow or second traffic flow being delivered.

3. The UE of claim 1, wherein the at least one processor is configured to cause the UE to, in response to starting the at least one MM-DSR timer, track a relative latency budget of completion of the second traffic flow with respect to completion of the first traffic flow via the at least one MM-DSR timer, and wherein the latency budget shrinks in response to the second traffic flow being completed.

4. The UE of claim 3, wherein the at least one processor is configured to cause the UE to stop the at least one MM-DSR timer at least based on exhausting the relative latency budget.

5. The UE of claim 3, wherein the at least one processor is configured to cause the UE to transmit a media access control (MAC) control element (CE) message indicating the relative latency budget.

6. The UE of claim 5, wherein the at least one processor is configured to cause the UE to transmit the MAC-CE message in response to absence of pending MM-DSRs, DSRs, buffer status reports (BSRs), or a combination thereof that have a higher priority than the at least one MM-DSR and wherein a DSR comprises an absolute latency budget of a traffic flow, and a BSR comprises a buffer status report.

7. The UE of claim 6, wherein pending MM-DSRs or DSRs have higher priorities than the at least one MM-DSR in response to an associated latency budget of the pending MM-DSRs or DSRs being less than the latency budget of the at least one MM-DSR.

8. The UE of claim 3, wherein the MAC-CE message comprises an associated buffer size for the second traffic flow.

9. The UE of claim 1, wherein the at least one processor is configured to cause the UE to trigger a first MM-DSR event in response to a value of the at least one MM-DSR timer being less than a threshold.

10. The UE of claim 1, wherein the at least one processor is configured to cause the UE to start the at least one MM-DSR timer in response to the at least one MM-DSR timer not being started prior to a packet of the first traffic flow being delivered.

11. The UE of claim 1, wherein the at least one processor is configured to cause the UE to start the at least one MM-DSR timer in response to the completion of at least a packet of the first traffic flow which has arrived in a buffer of the UE within a predetermined time window.

12. The UE of claim 1, wherein the at least one processor is configured to cause the UE to stop the at least one MM-DSR timer in response to exhaustion of a relative latency budget of at least one of the set of MM-DSR timers or exhaustion of an absolute latency budget of at least a packet of one of the multiple correlated traffic flows.

13. The UE of claim 1, wherein the at least one processor is configured to cause the UE to discard remaining packets of the multiple correlated traffic flows associated with the first traffic flow in response to the MM-DSR timer expiring.

14. A processor for wireless communication, comprising:
at least one controller coupled with at least one memory and configured to cause the processor to:
determine a multi-modal (MM) traffic identifier (ID) associated with multiple correlated traffic flows;
receive a configuration for a set of MM delay status report (DSR) timers, wherein at least one MM-DSR timer in the set of MM-DSR timers is associated with an ordered pair of traffic flows comprising a first traffic flow and a second traffic flow, the first and second traffic flows associated with the same MM ID; and
start the at least one MM-DSR timer associated with the first and second traffic flows in response to completion of the first traffic flow, the second traffic flow, or a combination of thereof.

15. The processor of claim 14, wherein the first traffic flow or the second traffic flow is completed in response to a set of associated packets of the first traffic flow or second traffic flow being delivered.

16. The processor of claim 14, wherein the at least one controller is configured to cause the processor to, in response to starting the at least one MM-DSR timer, track a relative latency budget of completion of the second traffic flow with respect to completion of the first traffic flow via the at least one MM-DSR timer, and wherein the latency budget shrinks in response to the second traffic flow being completed.

17. The processor of claim 16, wherein the at least one controller is configured to cause the processor to stop the at least one MM-DSR timer at least based on exhausting the relative latency budget.

18. The processor of claim 16, wherein the at least one controller is configured to cause the processor to transmit a media access control (MAC) control element (CE) message indicating the relative latency budget.

19. A method performed by a user equipment (UE), the method comprising:
determining a multi-modal (MM) traffic identifier (ID) associated with multiple correlated traffic flows;
receiving a configuration for a set of MM delay status report (DSR) timers, wherein at least one MM-DSR timer in the set of MM-DSR timers is associated with an ordered pair of traffic flows comprising a first traffic flow and a second traffic flow, the first and second traffic flows associated with the same MM ID; and
starting the at least one MM-DSR timer associated with the first and second traffic flows in response to completion of the first traffic flow, the second traffic flow, or a combination of thereof.

20. A network equipment (NE) for wireless communication, comprising:
at least one memory; and
at least one processor coupled with the at least one memory and configured to cause the NE to:
determine a set of multi-modal (MM) delay status report (DSR) timers;
transmit a configuration for configuring the set of MM-DSR timers, wherein at least one MM-DSR timer in the set of MM-DSR timers is associated with an ordered pair of traffic flows comprising a first traffic flow and a second traffic flow, the first and second traffic flows associated with the same MM identifier (ID); and
receive a message indicating a relative latency of completion of the second traffic flow with respect to completion of the first traffic flow via at least one MM-DSR timer of the set of MM-DSR timers.
